(19) United States
(12) Patent Application Publication
(10) Pub. No.: US 2026/0299658 A1
(43) Pub. Date: Oct. 1, 2026

(54) POWER ACCOUNTING FOR LOGICAL PARTITIONS USING POWER PROXY

(71) Applicant: INTERNATIONAL BUSINESS MACHINES CORPORATION, ARMONK, NY (US)

(72) Inventors: PRADEEP BHADRAVATI PARASHURAMA, BHADRAVATI (IN); TOBIAS WEBEL, SCHWAEBISCH-GMUEND (DE); ALPER BUYUKTOSUNOGLU, WHITE PLAINS, NY (US); RAMON BERTRAN MONFORT, NEW ORLEANS, LA (US); AISHWARYA RAJIV TADKASE, BANGALORE (IN); MUHSINA NEWMAN, ALAPPUZHA (IN)

(21) Appl. No.: 19/092,392

(22) Filed: Mar. 27, 2025

(51) Int. Cl. G06F 1/26

(52) U.S. Cl. CPC G06F 1/26

(57) ABSTRACT

Power accounting for logical partitions using power proxy according to an example includes generating, for each core in a multi-core computer system, a power proxy value indicating an amount of power consumed by the core during a time interval. The power accounting includes retrieving, from each core of the multi-core computer system during the time interval, an identification of a logical partition to which the core is allocated. The power accounting includes generating a power consumption distribution based on the power proxy value for each core and the identification from each core, wherein the power consumption distribution indicates a power consumption value for each of a plurality of logical partitions.

### BACKGROUND

The present disclosure relates to methods, apparatus, and products for power accounting for logical partitions using power proxy.

### SUMMARY

According to embodiments of the present disclosure, various methods, apparatus and products for power accounting for logical partitions using power proxy are described herein. In some aspects, power accounting for logical partitions using power proxy includes generating, for each core in a multi-core computer system, a power proxy value indicating an amount of power consumed by the core during a time interval. The power accounting includes retrieving, from each core of the multi-core computer system during the time interval, an identification of a logical partition to which the core is allocated. The power accounting includes generating a power consumption distribution based on the power proxy value for each core and the identification from each core, wherein the power consumption distribution indicates a power consumption value for each of a plurality of logical partitions.

### BRIEF DESCRIPTION OF THE DRAWINGS

FIG. 1 sets forth an example computing environment according to aspects of the present disclosure.

FIG. 2 sets forth an example multi-core computer system with power accounting for logical partitions according to aspects of the present disclosure.

FIG. 3 sets forth an example multi-core processor chip according to aspects of the present disclosure.

FIG. 4 sets forth an example processor core of a multi-core processor chip according to aspects of the present disclosure.

FIG. 5 sets forth example elements of a multi-core processor chip to facilitate power accounting for logical partitions according to aspects of the present disclosure.

FIG. 6 sets forth a method for power accounting for logical partitions using power proxy according to aspects of the present disclosure.

### DETAILED DESCRIPTION

Many modern processing devices, sometimes referred to as central processing units, or CPUs, are positioned on a single chip (or die, where the terms may be used interchangeably herein) as an integrated circuit. Many of these CPUs are multi-core processors, i.e., a computer processor on a single integrated circuit with two or more separate processing units, called cores, each of which reads and executes program instructions. These multiple cores may be powered through a steady-state power source.

Effective power management in microprocessors may involve a run-time measurement of power. However, the measurement of real, calibrated power consumption in hardware is often a difficult and complex task that may involve stalling the processor for proper calibration. In addition, isolating power consumption at the processor core level or chiplet level (e.g., combination of a core, level 2 (L2) cache, and level 3 (L3) cache) using only processor chip level power measurements may exacerbate the problem.

In large-scale computing environments, it is helpful to optimize energy usage and reduce operational costs. Measurement of core power consumption may not be possible, and only chip level direct measurements may be provided in some systems. However, logical partitions (LPARs) may be assigned to cores of a processor chip, and multiple LPARs may be assigned to the same processor chip and might be concurrently/simultaneously running on the chip during the direct measurement period. Without precise power accounting, it is challenging to manage resources effectively, leading to potential inefficiencies and higher costs. Measuring power consumption directly may involve detailed instrumentation at fine granularity.

On some mainframe servers, an accurate power accounting on a workload basis may not be provided. The workload may utilize different cores at different times in a dedicated or non-dedicated fashion. Some estimations may involve taking readings from off-chip voltmeters and approximating over the resource utilization. The power from the off chip voltmeters may be per chip readings and may not be fast enough to give a power utilized by a workload.

Some examples disclosed herein are directed to power accounting of LPARs using power proxy for sustainability. Some examples use power proxy signals to estimate the activity of a core, and this information is used to estimate the activity of LPARs distributed over the system. The power consumption breakup or distribution with respect to LPARs provided by some examples adds value towards sustainable solutions to optimize the workloads which run on an LPAR.

Some examples are directed to a computing system that uses power proxy logic to give an accurate estimation of power. Some examples use activity signals from processor cores, which are weighted according to calibration and accumulated over short intervals to give estimated dynamic power consumption of the chip. In some examples, the estimated power using the power proxy is per core and is evaluated at 32us to 32ms granularity.

Some examples disclosed herein are directed to a method for estimating the power consumption of a LPARs using the activity of a chip indicated by power proxy signals. Some examples are directed to a method for distributing the actual power measured of the chip into LPARs in the system. Some examples are directed to a method for distributing non-core power within a chip to different LPARs.

An example of the present disclosure is directed to a method, which includes generating, for each core in a multi-core computer system, a power proxy value indicating an amount of power consumed by the core during a time interval. The method includes retrieving, from each core of the multi-core computer system during the time interval, an identification of a logical partition to which the core is allocated. The method includes generating a power consumption distribution based on the power proxy value for each core and the identification from each core, where the power consumption distribution indicates a power consumption value for each of a plurality of logical partitions.

In some examples of the method, power proxy logic in each core performs the generating, for each core in the multi-core computer system, the power proxy value. In some examples, an on-chip microcontroller of the multi-core computer system performs the retrieving, from each core of the multi-core computer system, the identification of the logical partition, and the method further includes retrieving, by the on-chip microcontroller, the power proxy value for each core. Some examples of the method further include maintaining, by the on-chip microcontroller, a plurality of tables, wherein each of the tables respectively corresponds to one of the plurality of logical partitions. Some examples of the method further include identifying, for each core of the multi-core computer system, one of the tables based on the identification of the logical partition to which the core is allocated; and updating, for each core of the multi-core computer system, the identified one of the tables for the core based on the power proxy value for the core.

In some examples of the method, the multi-core computer system includes a hypervisor to manage the plurality of logical partitions, and the method further includes: storing, by the hypervisor, in a register of a first core of the multi-core computer system, when the first core is allocated to one of the plurality of logical partitions, the identification of the logical partition to which the first core is allocated; and retrieving, by an on-chip microcontroller of the multi-core computer system, from the register of the first core during the time interval, the identification of the logical partition.

In some examples, the method further includes generating a non-core power proxy value indicating an amount of power consumed by non-core circuitry of the multi-core computer system during the time interval, and where generating a power consumption distribution includes dividing the amount of power consumed by the non-core circuitry across logical partitions identified by the identification retrieved from each core of the multi-core computer system. In some examples, the dividing the amount of power consumed by the non-core circuitry is performed in proportion to core-related power consumption of each of the logical partitions identified by the identification retrieved from each core of the multi-core computer system.

In some examples, the method further includes generating a memory chip power proxy value based on a count of memory accesses during the time interval, where the memory chip power proxy value indicates an amount of power consumed by a memory chip coupled to the multi-core computer system during the time interval, and where generating a power consumption distribution includes dividing the amount of power consumed by the memory chip across logical partitions identified by the identification retrieved from each core of the multi-core computer system. In some examples, the method further includes generating an input/output chip power proxy value based on a count of input/output accesses during the time interval, where the input/output chip power proxy value indicates an amount of power consumed by an input/output chip coupled to the multi-core computer system during the time interval, and where generating a power consumption distribution includes dividing the amount of power consumed by the input/output chip across logical partitions identified by the identification retrieved from each core of the multi-core computer system.

Another example of the present disclosure is directed to a multi-core computer system comprising, which includes a processor set, and one or more computer-readable storage media. The multi-core computer system includes program instructions stored on the one or more storage media to cause the processor set to perform operations, which include generating, for each core in the multi-core computer system, a power proxy value indicating an amount of power consumed by the core during a time interval. The operations include retrieving, from each core of the multi-core computer system during the time interval, an identification of a logical partition to which the core is allocated. The operations include generating a power consumption distribution based on the power proxy value for each core and the identification from each core, wherein the power consumption distribution indicates a power consumption value for each of a plurality of logical partitions.

In some examples of the multi-core computer system, the operations further include maintaining a plurality of tables, wherein each of the tables respectively corresponds to one of the plurality of logical partitions. In some examples, the operations further include: identifying, for each core of the multi-core computer system, one of the tables based on the identification of the logical partition to which the core is allocated; and updating, for each core of the multi-core computer system, the identified one of the tables for the core based on the power proxy value for the core.

In some examples of the multi-core computer system, the operations further include: storing, in a register of a first core of the multi-core computer system, when the first core is allocated to one of the plurality of logical partitions, the identification of the logical partition to which the first core is allocated; and retrieving, from the register of the first core during the time interval, the identification of the logical partition.

In some examples of the multi-core computer system, the operations further include generating a non-core power proxy value indicating an amount of power consumed by non-core circuitry of the multi-core computer system during the time interval, and where generating a power consumption distribution includes dividing the amount of power consumed by the non-core circuitry across logical partitions identified by the identification retrieved from each core of the multi-core computer system. In some examples, the dividing the amount of power consumed by the non-core circuitry is performed in proportion to core-related power consumption of each of the logical partitions identified by the identification retrieved from each core of the multi-core computer system.

Another example of the present disclosure is directed to a computer program product, which includes one or more computer-readable storage media. The computer program product includes program instructions stored on the one or more storage media to perform operations, which include generating, for each core in the multi-core computer system, a power proxy value indicating an amount of power consumed by the core during a time interval. The operations include retrieving, from each core of the multi-core computer system during the time interval, an identification of a logical partition to which the core is allocated. The operations include generating a power consumption distribution based on the power proxy value for each core and the identification from each core, where the power consumption distribution indicates a power consumption value for each of a plurality of logical partitions.

In some examples of the computer program product, the operations further include maintaining a plurality of tables, wherein each of the tables respectively corresponds to one of the plurality of logical partitions. In some examples, the operations further include: identifying, for each core of the multi-core computer system, one of the tables based on the identification of the logical partition to which the core is allocated; and updating, for each core of the multi-core computer system, the identified one of the tables for the core based on the power proxy value for the core.

In some examples of the computer program product, the operations further include: storing, in a register of a first core of the multi-core computer system, when the first core is allocated to one of the plurality of logical partitions, the identification of the logical partition to which the first core is allocated; and retrieving, from the register of the first core during the time interval, the identification of the logical partition.

In some examples of the computer program product, the operations further include generating a non-core power proxy value indicating an amount of power consumed by non-core circuitry of the multi-core computer system during the time interval, and where generating a power consumption distribution includes dividing the amount of power consumed by the non-core circuitry across logical partitions identified by the identification retrieved from each core of the multi-core computer system.

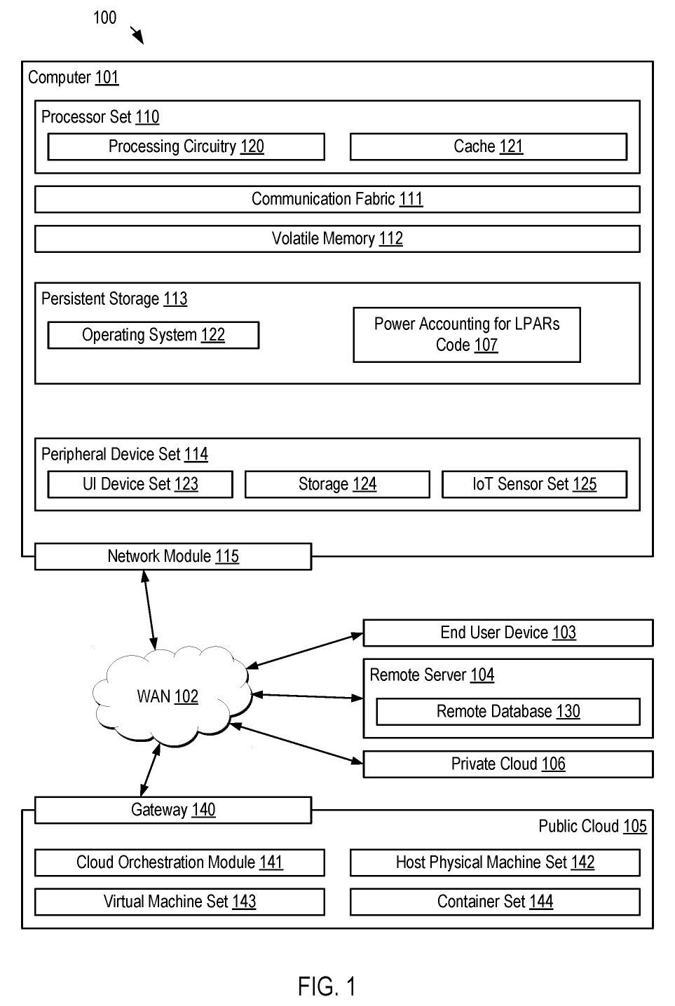

FIG. 1 sets forth an example computing environment according to aspects of the present disclosure. Computing environment 100 contains an example of an environment for the execution of at least some of the computer code involved in performing the various methods described herein, such as power accounting for LPARs code 107. In addition to power accounting for LPARs code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and power accounting for LPARs code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in power accounting for LPARs code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in power accounting for LPARs code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

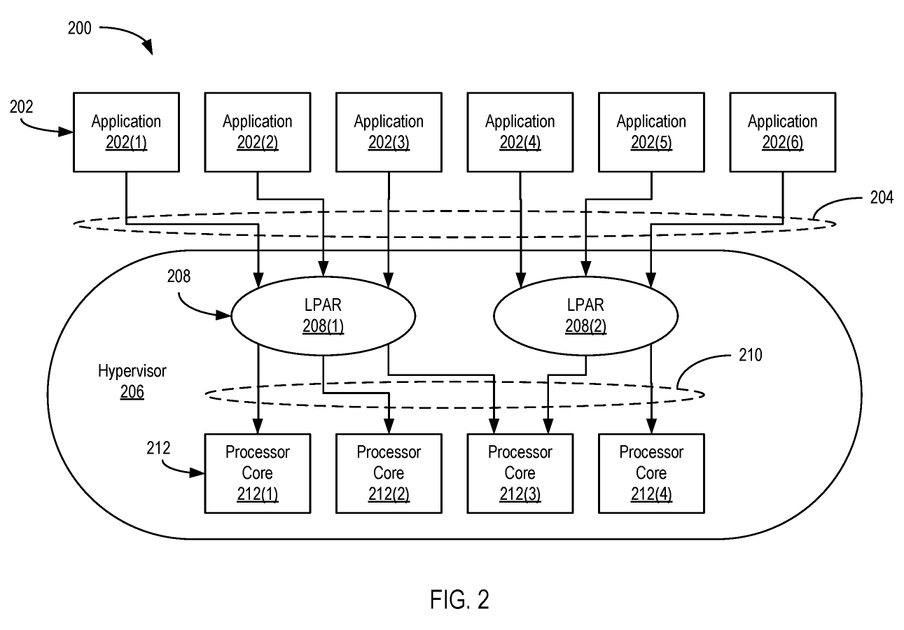

FIG. 2 sets forth an example multi-core computer system 200 with power accounting for logical partitions according to aspects of the present disclosure. Multi-core computer system 200 may include some or all of power accounting for LPARs code 107 (FIG. 1) to perform functions described herein. Multi-core computer system 200 includes a plurality of processor cores 212(1)-212(4) (collectively referred to as processor cores 212). Although four processor cores 212 are shown in the illustrated example, other examples may include more or less than four processor cores 212. Multi-core computer system 200 is organized into a plurality of logical partitions (LPARs) 208(1)-208(2) (collectively referred to as LPARs 208). Although two LPARs 208 are shown in the illustrated example, other examples may include more or less than two LPARs 208. A plurality of applications 202(1)-202(6) (collectively referred to as applications 202) are run by the LPARs 208. As shown in FIG. 2, applications 202(1)-202(3) are executed by LPAR 208(1), and applications 202(4)-202(6) are executed by LPAR 208(2). Although six applications 202 are shown in the illustrated example, other examples may include more or less than six applications 202.

Multiple LPARs 208 can coexist on a single machine, with each operating independently from the others. Multiple LPARs 208 may operate on a single or multiple physical processors in a time sliced manner. This allows for optimized use of hardware and flexibility in resource management. Each LPAR 208 may be capable of functioning as a separate system. That is, each LPAR 208 may be independently reset, initially loaded with an operating system, if desired, and operate with different applications.

A hypervisor 206 may operate as a logical partition manager and may include software/firmware that allows multiple operating systems to share a single hardware host. Hypervisor 206 provides the abstraction between the physical hardware and the virtualized environments (such as a LPARs 208). Hypervisor 206 dispatches workloads to different processor cores 212. In some examples, hypervisor 206 writes identifying information for an LPAR 208 (e.g., an LPAR ID) into a physical core control register when an LPAR logical core is running on that physical core 212. In a “dedicated” LPAR 208, specific physical resources (e.g., processor cores 212 and/or memory) are assigned exclusively to that LPAR 208. These resources are not shared with other LPARs 208. In a “non-dedicated” LPAR 208, resources are shared among multiple LPARs 208. The hypervisor 206 dynamically allocates resources on demand. The hypervisor 206 can reallocate resources to LPARs 208 that need them, leading to more efficient use of the physical hardware. In some systems, a processor core 212 is occupied by a single LPAR 208 at any given time. Some examples of multi-core computer system 200 are implemented as a server that can host up to eighty-five LPARs 208. As shown in FIG. 2, LPAR 208(1) is associated with cores 212(1), 212(2), and 212(3). LPAR 208(2) is associated with cores 212(3) and 212(4). Thus, core 212(3) is shared by both LPARs 208(1) and 208(2), with only one of the LPARs 208(1) or 208(2) being assigned to the core 212(3) at any given time.

In some examples, hypervisor 206 is a first-level hypervisor that manages the LPARs 208. In some examples, a second-level hypervisor may run in one or more of the LPARs 208, and perform functions such as transparent time-slicing of resources between multiple operating systems, and isolation of operating systems from one another within the LPAR 208. When a second-level hypervisor is running in an LPAR 208 and is running a program (e.g., an application 202) in a virtual machine, the second-level hypervisor may be referred to as guest1 210, and the program running in its virtual machine may be referred to as guest2 204.

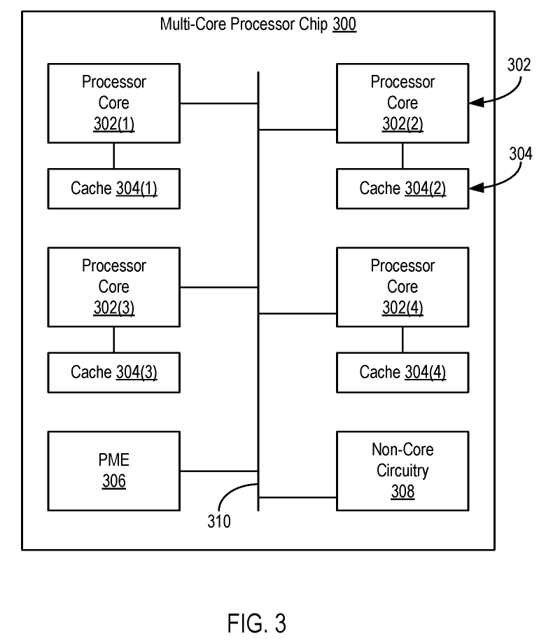

FIG. 3 sets forth an example multi-core processor chip 300 according to aspects of the present disclosure. Multi-core processor chip 300 may be included as part of multi-core computer system 200 (FIG. 2) and may include some or all of power accounting for LPARs code 107 (FIG. 1) to perform functions described herein. Multi-core processor chip 300 includes a plurality of processor cores 302(1)-302(4) (collectively referred to as processor cores 302), a plurality of caches 304(1)-304(4) (collectively referred to as caches 304), a power management engine (PME) 306, and non-core circuitry 308. The plurality of processor cores 302(1)-302(4) are coupled to the plurality of caches (e.g., L2/L3 caches) 304(1)-304(4), respectively. Although four processor cores 302 and four caches 304 are shown in the illustrated example, other examples may include more or less than four processor cores 302 and four caches 304. PME 306 is communicatively coupled to processor cores 302 and non-core circuitry 308 via communication link 310. In some examples, PME 306 is implemented as an on-chip microcontroller running on the chip 300.

In some examples, each of the processor cores 302 and the non-core circuitry 308 generates a power proxy value at regular intervals to give an estimate of power consumed by that processor core 302 or non-core circuitry 308. In some examples, PME 306 reads the power proxy value from each of the processor cores 302 and the non-core circuitry 308, and performs power accounting for LPARs functions, as described in further detail below.

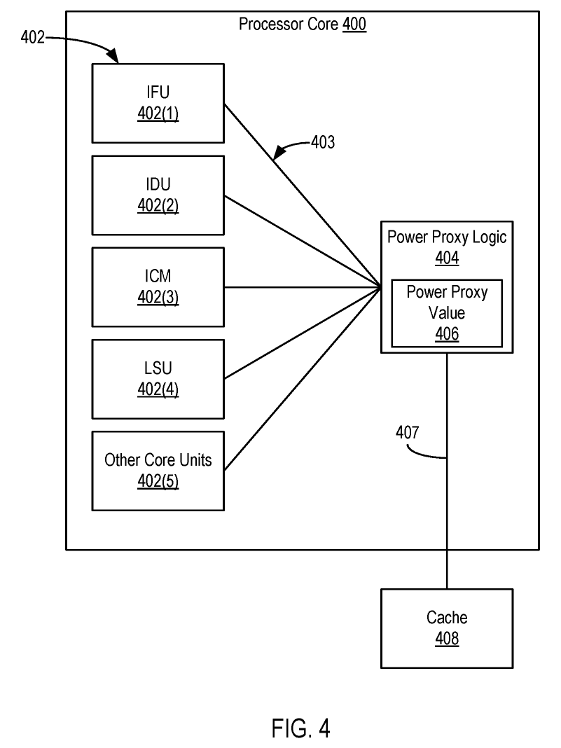

FIG. 4 sets forth an example processor core 400 of a multi-core processor chip according to aspects of the present disclosure. Processor core 400 is an example implementation of any or all of the processor cores 302 of multi-core processor chip 300 (FIG. 3), and may include some or all of power accounting for LPARs code 107 (FIG. 1) to perform functions described herein. Processor core 400 includes a plurality of core units 402(1)-402(5) (collectively referred to as core units 402) and power proxy logic 404. In some examples, the core units 402 include instruction fetch unit (IFU) 402(1), instruction decode unit (IDU) 402(2), instruction cache and merge unit (ICM) 402(3), load store unit (LSU) 402(4), and other core units 402(5).

Power proxy logic 404 is communicatively coupled to core units 402 via one or more communication links 403. Power proxy logic 404 is also coupled to cache 408 via communication link 407. Based on communications with the core units 402 and cache 408, power proxy logic 404 generates a power proxy value 406. In some examples, core units 402 and cache 408 send power activity signals to power proxy logic 404, which periodically accumulates the received signals and generates the power proxy value 406. In some examples, each of the processor cores 302 and the non-core circuitry 308 of multi-core processor chip 300 (FIG. 3) includes its own power proxy logic 404 to generate its own current power proxy value 406 to provide to PME 306.

The power proxy logic 404 in each processor core estimates the amount of power currently being consumed by that processor core. As processing activity increases in any given processor core, the amount of power consumed will increase, and the estimate, represented by the power proxy value 406, will indicate a change in the amount of processing activity by the processor core. In some examples, the power proxy value 406 represents a current processor core level power consumption estimate. In other examples, the power proxy value 406 represents a current chiplet level (e.g., combination of a processor core, level 2 (L2) cache, and level 3 (L3) cache) power consumption estimate. The power proxy values 406 may be generated at the highest chip frequency and may therefore be faster than a chip power measurement which might have a large latency. For example, an LPAR may change at a 12ms interval, and the PME 306 may collect power proxy values 406 in about 100us. The power proxy logic 404 is also hardware, in some examples, is faster running at core frequency, and may provide output every few cycles. In contrast, an actual chip power measurement might take up to one second.

In some examples, power proxy values 406 are real-time power proxy estimates that are generated through determining if a core is executing instructions or not and apply a weighting factor value to the present instructions being executed over a predetermined period of time, for example, and without limitation, 8 cycles. The weighting values may be obtained through empirical characterization obtained by running numerous workloads through the respective processor cores, and collecting the power consumption data for the particular instructions being executed. Through mathematical formula, the weighting factors may be estimated and the calculated estimations are compared with the actual values of the power consumed for the respective workloads. Therefore, accurate estimations of real-time power draw data are generated based on collected real-time processor activity.

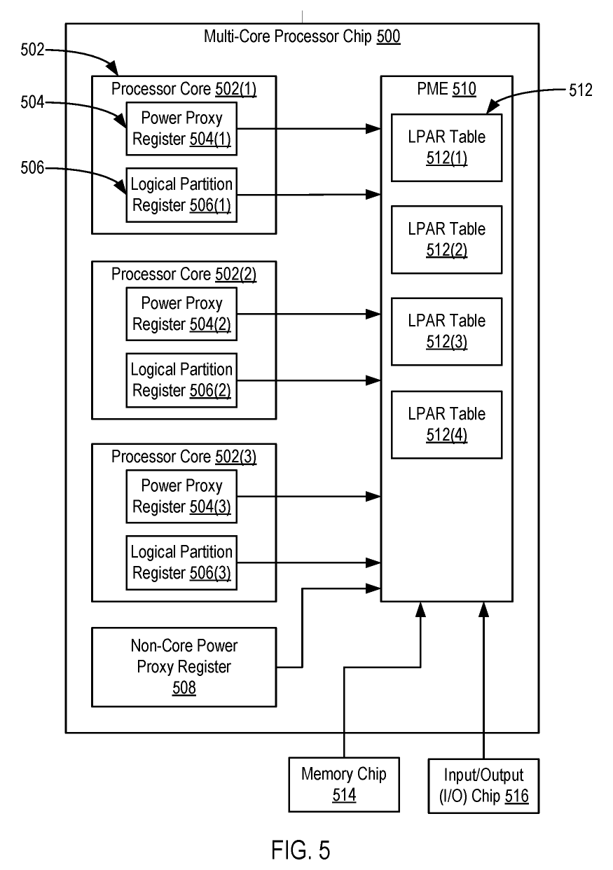

FIG. 5 sets forth example elements of a multi-core processor chip 500 to facilitate power accounting for logical partitions according to aspects of the present disclosure. Multi-core processor chip 500 may be included as part of multi-core computer system 200 (FIG. 2) and may include some or all of power accounting for LPARs code 107 (FIG. 1) to perform functions described herein. Multi-core processor chip 500 includes a plurality of processor cores 502(1)-502(3) (collectively referred to as processor cores 502), non-core power proxy register 508, and power management engine (PME) 510. Although three processor cores 502 are shown in the illustrated example, other examples may include more or less than three processor cores 502. In some examples, PME 510 is implemented as an on-chip microcontroller running on the chip 500.

In some examples, each of the processor cores 502 includes power proxy hardware logic (e.g., power proxy logic 404) that receives ongoing chip activity signals, which may be referred to as power proxy signals. In some examples, the power proxy logic 404 scales the power proxy signals according to pre-calibrated coefficients and accumulates the scaled values to generate a total activity value, which may be referred to herein as a long term activity proxy (LTAP) value. An LTAP value may be periodically generated for each of the processor cores 502 and may be generated for the entire processor chip 500. The LTAP values may be repeatedly generated/updated at a regular interval. In some examples, the processor cores 502(1)-502(3) include power proxy registers 504(1)-504(3) (collectively referred to as power proxy registers 504), respectively, to store the current LTAP value for that processor core. In some examples, non-core circuitry of processor chip 500 may also include power proxy hardware logic that receives power proxy signals, scales the power proxy signals according to pre-calibrated coefficients, and accumulates the scaled values to generate an LTAP value for the non-core circuitry, which may be stored in non-core power proxy register 508.

Processor cores 502(1)-502(3) also include logical partition registers 506(1)-506(3) (collectively referred to as logical partition registers 506), respectively, each of which may be used to store an LPAR ID. In some examples, when a hypervisor (e.g., hypervisor 206 in FIG. 2) allocates a particular one of the processor cores to a particular LPAR, the LPAR ID of that LPAR is stored in the logical partition register 506 of that processor core.

PME 510 includes a plurality of LPAR tables 512(1)-512(4) (collectively referred to as LPAR tables 512). Although four LPAR tables 512 are shown in the illustrated example, other examples may include more or less than four LPAR tables 512. Each of the LPAR tables 512 corresponds to a particular LPAR. For example, LPAR table 512(1) may correspond to a first LPAR, LPAR table 512(2) may correspond to a second LPAR, LPAR table 512(3) may correspond to a third LPAR, and LPAR table 512(4) may correspond to a fourth LPAR. In some examples, PME 510 periodically collects the LTAP value (e.g., from a power proxy register 504) and the associated LPAR ID (e.g., from a logical partition register 506) from each of the processor cores 502, and stores, for each of the processor cores 502, the LTAP value of that core 502 into the LPAR table 512 whose index matches with the LPAR ID running on that core 502. In some examples, each LPAR table 512 includes the power consumed by each of the processor cores 502 for the LPAR associated with that LPAR table. In some examples, the PME 510 creates a map of LPAR ID in a chip and corresponding LTAP value of the core and keeps accumulating it to the respective LPAR ID. In some examples, the PME 510 also increments a counter corresponding to that LPAR table 512 to determine how many times the LTAP value has accumulated. In some examples, the PME 510 runs in a loop at a regular period, and reads the LTAP values and associated LPAR IDs from the processor cores 502 during each iteration. In this manner, PME 510 generates a power consumption distribution based on the power proxy value for each core and the LPAR identification from each core, and in some examples, the power consumption distribution indicates a power consumption value for each of a plurality of logical partitions.

The non-core power proxy activity for a processor chip as represented by the LTAP value in register 508 may be distributed to only the LPARs utilized by the chip 500. In some examples, the non-core activity may be divided proportionally. For example, a first processor chip’s non-core power may be attributed to all the LPARs that were seen by all the cores of the first processor chip for that interval, and the non-core power may be divided amongst those LPARs in proportion to the LTAP values seen by those LPARs on the first processor chip.

Other power proxy activity, such as off-chip (e.g., outside of the multi-core processor chip 500) activity may also be distributed to the LPARs utilized by the chip 500. For example, FIG. 5 shows multi-core processor chip 500 coupled to a memory chip 514 and an input/output (I/O) chip 516. In some examples, the memory chip 514 and the I/O chip 516 are separate chips relative to the multi-core processor chip 500 and may provide power proxy information to multi-core processor chip 500 to include in the LPAR tables 512. In some examples, the multi-core processor chip 500 may include counters to count the number of LOAD/STORE memory accesses to memory chip 514 during an interval (e.g., LOAD/STORE accesses that missed the cache hierarchy and go to the memory chip 514, which may be a DRAM memory chip in some examples. The multi-core processor chip 500 may distribute the counted number of LOAD/STORE accesses across all the LPARs seen by all the cores 502 of the chip 500 in the interval, or may determine a power proxy value associated with the counted number of LOAD/STORE accesses, and distribute the power proxy value across all the LPARs seen by all the cores 502 of the chip 500 in the interval. For example, during a given interval of collecting power proxy values for the different cores 502 of the chip 500, the number of LOAD/STOREs during this interval may be counted. If, during the given interval, the cores 502 saw LPAR ID 5 and LPAR ID 6, and no other LPAR IDs were seen by the cores 502 during the interval, then the LOAD/STORE count may be divided equally between LPAR ID 5 and LPAR ID 6. As another example, if LPAR ID 5 was seen in two cores 502 during the interval while LPAR ID 6 was seen in four cores 502, then the LOAD/STORE count may be divided in a 1:2 ratio for LPAR 5 and LPAR 6.

In some examples, the multi-core processor chip 500 may include a counter to count the number of I/O accesses to I/O chip 516 during an interval. The multi-core processor chip 500 may distribute the counted number of I/O accesses across all the LPARs seen by all the cores 502 of the chip 500 in the interval, or may determine a power proxy value associated with the counted number of I/O accesses, and distribute the power proxy value across all the LPARs seen by all the cores 502 of the chip 500 in the interval. In some examples, system power may be read by a power source, and the estimation of the power consumed by the multi-core processor chip 500 as indicated by the power proxy values may be subtracted from this system power value. The remaining power may be distributed to one or more memory chips and one or more I/O chips based on the LOAD/STORE counts and the I/O access counts, respectively.

Some computing systems may include a plurality of multi-core processor chips, such as processor chip 500. In such systems, each of the processor chips may include the same set of LPAR tables 512, with each of the LPAR tables 512 corresponding to one of the LPARs, but the data in the LPAR tables may vary from chip to chip. In some examples, at a regular interval, these LPAR tables per chip may be output from the processor chips, processed and summed with respect to LPAR IDs (e.g., all of the tables corresponding to the first LPAR are summed, all of the LPAR tables corresponding to the second LPAR are summed, etc.). The result is a total activity proxy of the system according to the LPARs or a system level LPAR accounting, including a power consumption value for each LPAR. The system level LPAR accounting or power distribution may include power of one or more multi-chip processor chips, power of one or more memory chips, and power of one or more I/O chips. The system level LPAR accounting or power distribution may also include miscellaneous board power.

In some examples, the sampling time for the PME 510 to obtain LTAP values and LPAR IDs from the processor cores 502 is faster than the hypervisor workload switching time (i.e., the time for the hypervisor to assign LPARs to the processor cores 502) so no samples are missed. In some examples, the power estimation is at a millisecond granularity, capturing any power spikes due to the smallest workload. In some examples, the LTAP value units are in activity proxy numbers, which is relative to the power in watts. The power may be estimated in wattage at the rate of power proxy generation. This gives the power in watts per LPAR using the formula used for calibration of power proxy. The non-core chip power may be distributed to all the LPARs seen on the chip in the interval with respect to the total number of cores seen by an LPAR and their LTAP value. For memory buffers and other IO cards, the number of load/store counts triggered from a core, which is handled by the chip IO logic, could be read by the PME 510, and using the counts of load/store originated from a core, the memory buffer chips could be divided into appropriate LPARs to get the system level LPAR power distribution.

Some examples use the power proxy signals to extend to level 2 of power estimation of firmware (e.g., guest2 204 shown in FIG. 2) which runs on an LPAR 208. In some examples, this is achieved when the power proxy information is sent to a hypervisor or higher-level firmware which dispatches the guest2 204 to a single or multiple LPARs 208.

Any workload consuming more than the usual power intended for the workload, as determined by examples disclosed herein, can give insights into efficiency improvements and also can give insights into a possible security breach. In some examples, the LPAR power accounting data may be saved, analyzed over long periods to know which processor cores peak for which duration, and some examples may proactively take actions such as giving higher voltages to chips, allocating more/less processor cores to a workload, switching off processor cores to save power, checking long term reliability of processor cores, and replacing a chip even before possible breakdown, etc.

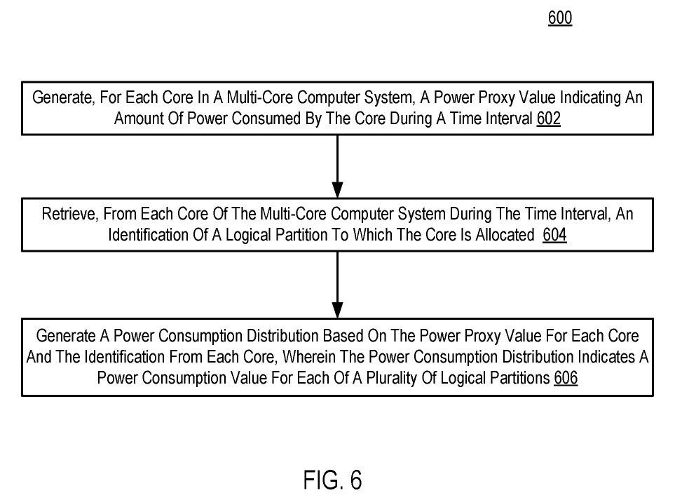

FIG. 6 sets forth a method 600 for power accounting for logical partitions using power proxy according to aspects of the present disclosure. In some examples, multi-core computer system 200 (FIG. 2) is configured to perform method 600 using power accounting for LPARs code 107 (FIG. 1). Method 600 includes generating 602, for each core in a multi-core computer system, a power proxy value indicating an amount of power consumed by the core during a time interval. Method 600 includes retrieving 604, from each core of the multi-core computer system during the time interval, an identification of a logical partition to which the core is allocated. Method 600 includes generating 606 a power consumption distribution based on the power proxy value for each core and the identification from each core, wherein the power consumption distribution indicates a power consumption value for each of a plurality of logical partitions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating, for each core in a multi-core computer system, a power proxy value indicating an amount of power consumed by the core during a time interval;
retrieving, from each core of the multi-core computer system during the time interval, an identification of a logical partition to which the core is allocated; and
generating a power consumption distribution based on the power proxy value for each core and the identification from each core, wherein the power consumption distribution indicates a power consumption value for each of a plurality of logical partitions.

2. The method of claim 1, wherein power proxy logic in each core performs the generating, for each core in the multi-core computer system, the power proxy value.

3. The method of claim 2, wherein an on-chip microcontroller of the multi-core computer system performs the retrieving, from each core of the multi-core computer system, the identification of the logical partition, and wherein the method further comprises:
retrieving, by the on-chip microcontroller, the power proxy value for each core.

4. The method of claim 3, and further comprising:
maintaining, by the on-chip microcontroller, a plurality of tables, wherein each of the tables respectively corresponds to one of the plurality of logical partitions.

5. The method of claim 4, and further comprising:
identifying, for each core of the multi-core computer system, one of the tables based on the identification of the logical partition to which the core is allocated; and
updating, for each core of the multi-core computer system, the identified one of the tables for the core based on the power proxy value for the core.

6. The method of claim 1, wherein the multi-core computer system includes a hypervisor to manage the plurality of logical partitions, and wherein the method further comprises:
storing, by the hypervisor, in a register of a first core of the multi-core computer system, when the first core is allocated to one of the plurality of logical partitions, the identification of the logical partition to which the first core is allocated; and
retrieving, by an on-chip microcontroller of the multi-core computer system, from the register of the first core during the time interval, the identification of the logical partition.

7. The method of claim 1, and further comprising:
generating a non-core power proxy value indicating an amount of power consumed by non-core circuitry of the multi-core computer system during the time interval, and wherein generating a power consumption distribution includes dividing the amount of power consumed by the non-core circuitry across logical partitions identified by the identification retrieved from each core of the multi-core computer system.

8. The method of claim 7, wherein the dividing the amount of power consumed by the non-core circuitry is performed in proportion to core-related power consumption of each of the logical partitions identified by the identification retrieved from each core of the multi-core computer system.

9. The method of claim 1, and further comprising:
generating a memory chip power proxy value based on a count of memory accesses during the time interval, wherein the memory chip power proxy value indicates an amount of power consumed by a memory chip coupled to the multi-core computer system during the time interval, and wherein generating a power consumption distribution includes dividing the amount of power consumed by the memory chip across logical partitions identified by the identification retrieved from each core of the multi-core computer system; and
generating an input/output chip power proxy value based on a count of input/output accesses during the time interval, wherein the input/output chip power proxy value indicates an amount of power consumed by an input/output chip coupled to the multi-core computer system during the time interval, and wherein generating a power consumption distribution includes dividing the amount of power consumed by the input/output chip across logical partitions identified by the identification retrieved from each core of the multi-core computer system.

10. A multi-core computer system comprising:
a processor set;
one or more computer-readable storage media; and
program instructions stored on the one or more storage media to cause the processor set to perform operations comprising:
generating, for each core in the multi-core computer system, a power proxy value indicating an amount of power consumed by the core during a time interval;
retrieving, from each core of the multi-core computer system during the time interval, an identification of a logical partition to which the core is allocated; and
generating a power consumption distribution based on the power proxy value for each core and the identification from each core, wherein the power consumption distribution indicates a power consumption value for each of a plurality of logical partitions.

11. The multi-core computer system of claim 10, wherein the operations further comprise:
maintaining a plurality of tables, wherein each of the tables respectively corresponds to one of the plurality of logical partitions.

12. The multi-core computer system of claim 11, wherein the operations further comprise:
identifying, for each core of the multi-core computer system, one of the tables based on the identification of the logical partition to which the core is allocated; and
updating, for each core of the multi-core computer system, the identified one of the tables for the core based on the power proxy value for the core.

13. The multi-core computer system of claim 10, wherein the operations further comprise:
storing, in a register of a first core of the multi-core computer system, when the first core is allocated to one of the plurality of logical partitions, the identification of the logical partition to which the first core is allocated; and
retrieving, from the register of the first core during the time interval, the identification of the logical partition.

14. The multi-core computer system of claim 10, wherein the operations further comprise:
generating a non-core power proxy value indicating an amount of power consumed by non-core circuitry of the multi-core computer system during the time interval, and wherein generating a power consumption distribution includes dividing the amount of power consumed by the non-core circuitry across logical partitions identified by the identification retrieved from each core of the multi-core computer system.

15. The multi-core computer system of claim 14, wherein the dividing the amount of power consumed by the non-core circuitry is performed in proportion to core-related power consumption of each of the logical partitions identified by the identification retrieved from each core of the multi-core computer system.

16. A computer program product comprising:
one or more computer-readable storage media; and
program instructions stored on the one or more storage media to perform operations comprising:
generating, for each core in a multi-core computer system, a power proxy value indicating an amount of power consumed by the core during a time interval;
retrieving, from each core of the multi-core computer system during the time interval, an identification of a logical partition to which the core is allocated; and
generating a power consumption distribution based on the power proxy value for each core and the identification from each core, wherein the power consumption distribution indicates a power consumption value for each of a plurality of logical partitions.

17. The computer program product of claim 16, wherein the operations further comprise:
maintaining a plurality of tables, wherein each of the tables respectively corresponds to one of the plurality of logical partitions.

18. The computer program product of claim 17, wherein the operations further comprise:
identifying, for each core of the multi-core computer system, one of the tables based on the identification of the logical partition to which the core is allocated; and
updating, for each core of the multi-core computer system, the identified one of the tables for the core based on the power proxy value for the core.

19. The computer program product of claim 16, wherein the operations further comprise:
storing, in a register of a first core of the multi-core computer system, when the first core is allocated to one of the plurality of logical partitions, the identification of the logical partition to which the first core is allocated; and
retrieving, from the register of the first core during the time interval, the identification of the logical partition.

20. The computer program product of claim 16, wherein the operations further comprise:
generating a non-core power proxy value indicating an amount of power consumed by non-core circuitry of the multi-core computer system during the time interval, and wherein generating a power consumption distribution includes dividing the amount of power consumed by the non-core circuitry across logical partitions identified by the identification retrieved from each core of the multi-core computer system.
